(19) United States
(12) Patent Application Publication
(10) Pub. No.: US 2003/0123676 A1
(43) Pub. Date: Jul. 3, 2003

(54) Method of deriving a head-related transfer function

(76) Inventor: Daniel Willem Elisabeth Schobben, Eindhoven (NL)

Correspondence Address: Philips Electronics North America Corporation, Corporate Patent Counsel, 580 White Plains Road, Tarrytown, NY, 10591, US

(21) Appl. No.: 10/276,785

(22) PCT Filed: Mar. 15, 2002
(86) PCT No.: PCT/IB02/00862

(30) Foreign Application Priority Data
Mar. 22, 2001 (EP) 01201074.0

(51) Int. Cl. H04R 5/00; H04R 1/10; H04R 5/02

(52) U.S. Cl. 381/74; 381/303; 381/309; 381/310; 381/26

(57) ABSTRACT

The invention relates to a method of deriving a head-related transfer function within a room. According to the invention, electrical signals of a sound pattern or music signals are supplied to a speaker, and sound waves are emitted from the speaker. The sound waves and sound waves reflected within the room act on a speaker of a headset and are converted by the headset speaker into electrical signals. Then an associated head related transfer function is derived from the electrical signals and stored. When headsets are used as microphones in a calibration mode, HRTFs can be assessed without inserting microphones into a listener's cars. Calibration by the end user is thus simplified.

The invention relates to a method of deriving a head-related transfer function within a room.

A method of and a device for deriving head-related transfer functions, abbreviated as HRTF, are described in U.S. Pat. No. 5,729,612. Head-related transfer functions are different for different listeners. A personal head-related transfer function must be produced for each listener. Thus, in the case of sound reproduction with a transfer function derived for a certain person, there will not be a good three-dimensional sound for one out of every three persons. To derive the function, a microphone is used which is inserted in the ear of a listener. Calibration of the headset for each listener as the end user is performed in his preferred room with his speakers. This is considered to be inconvenient. For all these reasons individually adapted headsets have not yet become available on the market.

The invention therefore has for its object to create a simple calibration for a headset.

This object is achieved by the features of claim 1. According to the invention, electrical signals representing a sound pattern or music signals are given to a speaker and sound waves are emitted from the speaker. The sound waves, and sound waves reflected within the room, subsequently act on a speaker of a headset and are converted by the headset speaker into electrical signals. Then an associated head-related transfer function is derived from the electrical signals and stored. When headsets are used as microphones in a calibration mode, HRTFs can be assessed without inserting the microphone into the ear of the user. Calibration for the end user can thus be simplified. The invention may also be integrated into an audio device in a simple manner and may be used for any type of headset. Thus compatibility is ensured for simple and even older headsets and the use of two microphones is made redundant.

Advantageously, the microphone properties of the headset speaker are taken into account in the derivation of transfer functions. When sound waves are directed at the headset speaker, the electrical signals used for reproduction and generated by the headset speaker can be compared with one another, and characteristic properties of the speaker can be determined and stored.

Electrical signals of a sound pattern are given in succession to each individual speaker of a music system in a simple manner, and a head-related transfer function is individually derived for each speaker. The procedure is repeated for all speakers of a music system. If one speaker is converted for each HRTF calculation, just one is required. If independent sound sequences are given simultaneously to the speakers, all HRTFs can be measured at once. External sound sources which generate a known sound may also be used. In practice, one speaker may also be used in the same location to derive all HRTFs if the person changes his/her position relative to the single speaker for each HRTF.

The head-related transfer function is used in a simple manner for reproduction via a headset.

Advantageously, the device for derivation of a head-related transfer function comprises a music system with at least one speaker, an apparatus with an electronic part for deriving a head-related transfer function, and a headset. Thus a head-related transfer function can be derived in a simple manner. The apparatus with an electronic part for deriving a head-related transfer function, the music system and the headset are connected together, and the apparatus gives a frequency pattern to the speaker via the music system. The sound waves and the sound waves broken at the walls are received in the speaker serving as a microphone and reproduced on the apparatus for deriving a head-related transfer function. During calibration the listener wears the headset, preferably an inner-ear headset with a foam surround, so that the sound reaches the speaker of the headset serving as microphone.

Advantageously, the apparatus comprises an adaptable filter. The adaptable filter is factory-fitted in the apparatus.

In a simple arrangement, the filter comprises a control unit and a speaker. A control unit and a speaker are suitable for deriving a head-related transfer function.

Advantageously, the apparatus comprises a sound generator. Thus a test signal can be factory-set in the apparatus.

Advantageously, the apparatus is a digital versatile disc player, abbreviated as DVD player. The arrangement may be implemented in devices which recently appeared on the market such as, for example, the disc player mentioned above.

For better understanding of the invention, an embodiment will now be described in more detail below with reference to the drawing, in which:

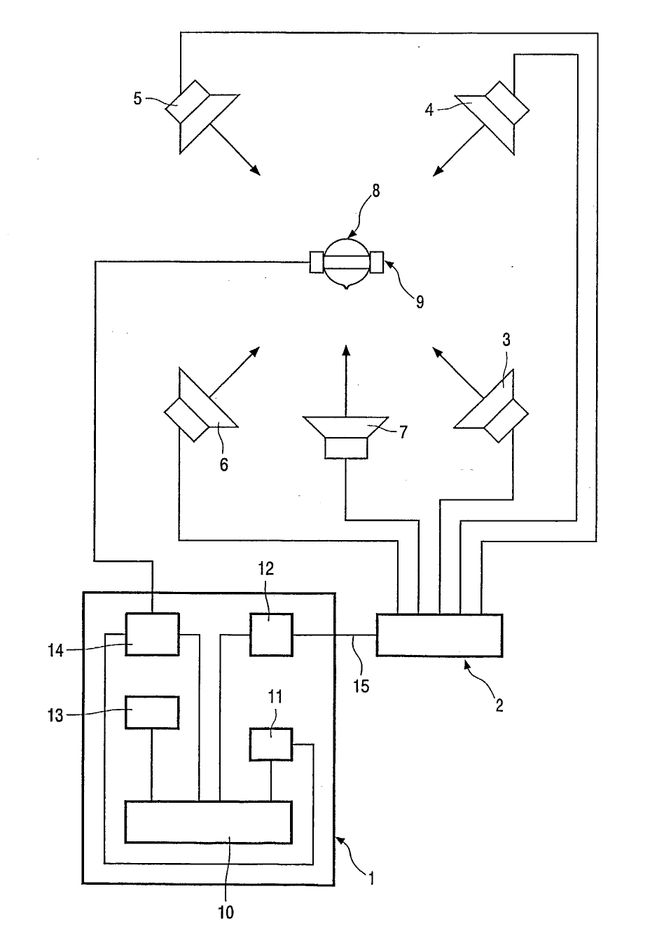

FIG. 1 shows a music system with five speakers, a test subject with a headset, and a block circuit diagram of a disc player which can be used for generating sound, for receiving sound via the headset, and for calculating transfer functions.

FIG. 1 shows a player 1, a music system 2, five speakers 3 to 7 and a test subject 8 with a headset 9. The player 1 is suitable for playing digital versatile discs, DVD for short, and has a control unit 10, an electronic and mechanical reproduction part 11, a sound generator 12, a memory 13, and an electronic reception and reproduction part 14. The speakers 3 and 6 are left and right front speakers. The speaker 7 is a central speaker, and the speakers 4 and 5 are left and right rear room speakers for surround sound. A deep bass speaker is not shown as its position within a room is not critical and its signal may be given directly to both speakers of a headset without deriving an HRTF.

To calculate an HRTF, the control unit 10 causes the sound generator 12 to give electrical signals to the music system 2 via a connecting line 15. The electrical signals constitute a frequency pattern. The music system 2 feeds this frequency pattern to the speaker 3. The speaker 3 generates sound waves which are broken up in the room and act on the speakers 16 and 17 of the headset 9. The sound waves act on the speaker membranes within the headset 9 and induce a current which is output in the form of two electrical signals to the receiver part 14 of the player. The control unit 10 acts as an adaptive filter and calculates the transfer function. In other words, the player 1 generates a series of sounds which are passed to one of the speakers 3 to 7 of the stereo system 2 during calibration. An adaptive filter 10, 13, which derives the transfer function from the speakers 3 to 7 for the ear of the listener 8, is integrated in the portable player 1. The calculation time is around 1 second.

The audio signal is filtered during reproduction by the appropriate head-related transfer function so as to give the listener 8 the impression that he/she is listening to a real speaker arrangement when he/she is using the headset.

The calibration of the head-related transfer function takes into account the microphone properties of the individual headset 9 used. In addition, the sound reproduction state contains the speaker characteristics of the headset 9. Both can be reset by adjusting with the product via the transfer functions. This product of the microphone and speaker transfer functions can be determined once for a particular headset by playing a sound frequency via one headset speaker and using the other headset speaker as a microphone. If a sound source to the left of a person emits a tone, this tone is first received by the left speaker of the headset which acts as a microphone. Slightly later the tone reaches the right speaker of the headset acting as a microphone. The transfer function from the left to the right ear can thus be measured in the same way as the transfer functions from the speakers to the headset speakers used as microphones. There is accordingly a description of how the sound present at the left ear is propagated to the right ear. In order to simulate a left rear room speaker, the left rear room signal is now filtered with a person-independent HRTF and reproduced via the left headset speaker. The signal for the left headset speaker can therefore also be generated by the transfer function measured from the left to the right ear and reproduced via the right headset speaker. One advantage of this measurement is that the property of using the headset speaker as a microphone does not change the measurement, because this property for using the headset speakers as microphones is present in both the right and the left signal.

### REFERENCE LIST

1. Disc player

2. Music system

3. Speaker

4. Speaker

5. Speaker

6. Speaker

7. Speaker

8. Test subject

9. Headset

10. Control unit

11. Electrical and mechanical reproduction part

12. Sound generator

13. Memory

14. Electrical reception and reproduction part

15. Connecting line

1. A method of deriving a head-related transfer function within a room, characterized by the following process steps:
electrical signals of a sound pattern are supplied to a speaker (3 to 7) and sound waves are emitted by the speaker (3 to 7),
the sound waves and sound waves reflected within the room act on a speaker of the headset (9) and are converted by the headset speaker (9) into electrical signals, and
an associated head-related transfer function is derived from the electrical signals and stored.

2. A method as claimed in claim 1, characterized in that the microphone properties of the headset speaker are taken into account in the derivation of the transfer function.

3. A method as claimed in claim 1, characterized in that electrical signals of a sound pattern are given in succession to each individual speaker (3 to 7) of a music system (2), and a head-related transfer function is individually derived for each speaker (3 to 7).

4. A method as claimed in claim 1, characterized in that the head-related transfer function is used for reproduction via the headset (9).

5. An apparatus for deriving a head-related transfer function in a room, characterized in that the apparatus comprises a music system (2) with at least one speaker (3 to 7), a device (1) with an electronic part (10, 13) for deriving a head-related transfer function, and a headset (9).

6. A device for a method as claimed in claim 1, characterized in that the device (1) has an adaptable filter (10, 13).

7. A device as claimed inclaim 4, characterized in that the filter (10, 13) has a control unit (10) and a memory (13).

8. A device as claimed inclaim 4 or 5, characterized in that the device (1) has a sound generator (12).

9. A device as claimed in any one of the preceding claims 4 to 6, characterized in that the device (1) is a video disc player.
